(19) United States
(12) Patent Application Publication
(10) Pub. No.: US 2012/0085255 A1
(43) Pub. Date: Apr. 12, 2012

(54) PRINTING APPARATUS AND METHOD OF FORMING PATTERN USING THE SAME

(76) Inventors: Dae-Young LEE, Suwon-si (KR); Kyu Young Kim, Suwon-si (KR); Youngu Lee, Suwon-si (KR); Namok Jung, Suwon-si (KR)

(21) Appl. No.: 13/165,386

(22) Filed: Jun. 21, 2011

(30) Foreign Application Priority Data
Oct. 7, 2010 (KR) 10-2010-0097924

(51) Int. Cl. B41F 1/40; B41F 3/34

(52) U.S. Cl. 101/340; 101/492

(57) ABSTRACT

A printing apparatus includes a master board and a feeding part. The master board includes first and second planes different from each other, a patterned reservoir formed on the first plane, and an injection hole connected to the patterned reservoir by extending from the second plane through an inside of the master board. The feeding part feeds the ink into the patterned reservoir through the injection hole. The ink is supplied to the patterned reservoir through the injection hole. The feeding part feeds a predetermined amount of ink into the patterned reservoir through the injection hole so that the ink is prevented from overflowing out of the patterned reservoir. Thus, an additional process to remove ink overflowing out of the patterned reservoir is not necessary.

### CROSS-REFERENCE TO RELATED APPLICATION

This application relies for priority upon Korean Patent Application No. 10-2010-0097924 filed on Oct. 7, 2010, the content of which is herein incorporated by reference in its entirety.

### BACKGROUND

1. Field of disclosure

The present invention relates to a printing apparatus and a method of forming a pattern using the same. More particularly, the present invention relates to a printing apparatus and a method of forming a pattern using the same, capable of shortening process time to form the pattern.

2. Description of the Related Art

In general, a photolithography method is used to form a pattern on a substrate of a display apparatus. According to the photolithography method, a thin film forming process, an exposure and development process, and an etching process are performed to form the pattern on the substrate. That is, many unit processes are necessary in order to form the pattern through the photolithography method.

Recently, alternative methods of forming patterns, such as a printing method, have been proposed. According to the printing method, ink is supplied onto a master board having patterned reservoirs, until the ink fills the patterned reservoirs. A blade is used to remove excess ink that spills out of the patterned reservoirs. Then, the ink filled in the patterned reservoirs is transferred to a substrate via a transfer member, so that patterns corresponding to the patterned reservoirs are formed on the substrate.

### SUMMARY

Exemplary embodiments of the present invention provide a printing apparatus capable of shortening the process time to form a pattern on a substrate.

Exemplary embodiments of the present invention also provide a method of forming a pattern by using the printing apparatus.

According to the exemplary embodiments, a printing apparatus includes a master board and a feeding part. The master board includes first and second planes different from each other, a patterned reservoir formed on the first plane of the master board and an injection hole connected to the patterned reservoir by extending from the second plane through an inside of the master board. The feeding part feeds ink into the patterned reservoir through the injection hole.

According to the exemplary embodiments, there is provided a method of forming a pattern using a master board having a patterned reservoir formed on a first plane .

Ink is fed into the patterned reservoir through an injection hole connected to the patterned reservoir by extending from a second plane different from the first plane through an inside of the master board. The ink in the patterned reservoir is transferred to a transfer member and the pattern is formed on a substrate by transferring the ink from the transfer member to the substrate.

According to one exemplary embodiment of the present invention, a color filter pattern can be formed on a substrate of a display apparatus through the method of forming the pattern.

According to another exemplary embodiment of the present invention, a black matrix pattern can be formed on a substrate of a display apparatus through the method of forming the pattern.

The ink can be supplied to the patterned reservoir through the injection hole formed in the master board. In addition, the feeding part can supply a predetermined amount of ink into the patterned reservoir through the injection hole so that the ink can be prevented from overflowing out of the patterned reservoir. With this measured supply, any removal of the ink overflowing out of the patterned reservoir is not necessary. Hence, the process of forming the pattern using the printing apparatus can be simplified.

### BRIEF DESCRIPTION OF THE DRAWINGS

The above and other advantages of the present invention will become readily apparent by reference to the following detailed description when considered in conjunction with the accompanying drawings wherein:

FIG. 1 is a side view of a printing apparatus according to an exemplary embodiment of the present invention;

FIG. 2 is a side view of a printing apparatus according to another exemplary embodiment of the present invention;

FIG. 3 is a side view of a printing apparatus according to still another exemplary embodiment of the present invention;

FIGS. 4A and 4B are perspective views of a printing apparatus according to still another exemplary embodiment of the present invention;

FIG. 5A is a sectional view taken along line I-I′ of FIG. 4A;

FIG. 5B is a sectional view taken along line 11-II′ of FIG. 4B;

FIG. 6 is a side view of a printing apparatus according to still another embodiment of the present invention;

FIGS. 7 to 9 are views showing a method of forming a pattern using a printing apparatus shown in FIG. 1; and

FIGS. 10A and 10B are views showing a method of forming a color filter pattern and a black matrix pattern on a substrate of a display apparatus by using the method of forming the pattern shown in FIGS. 7 to 9.

### DETAILED DESCRIPTION

Hereinafter, exemplary embodiments of the present invention will be described in detail with reference to accompanying drawings. However, the present invention is not limited to the following embodiments but includes various changes, substitutions and modifications within the technical scope of the present invention. In the drawings, the sizes of layers and regions may be magnified or simplified for the purpose of clear explanation. The same reference numerals will be used to refer to the same elements throughout the drawings.

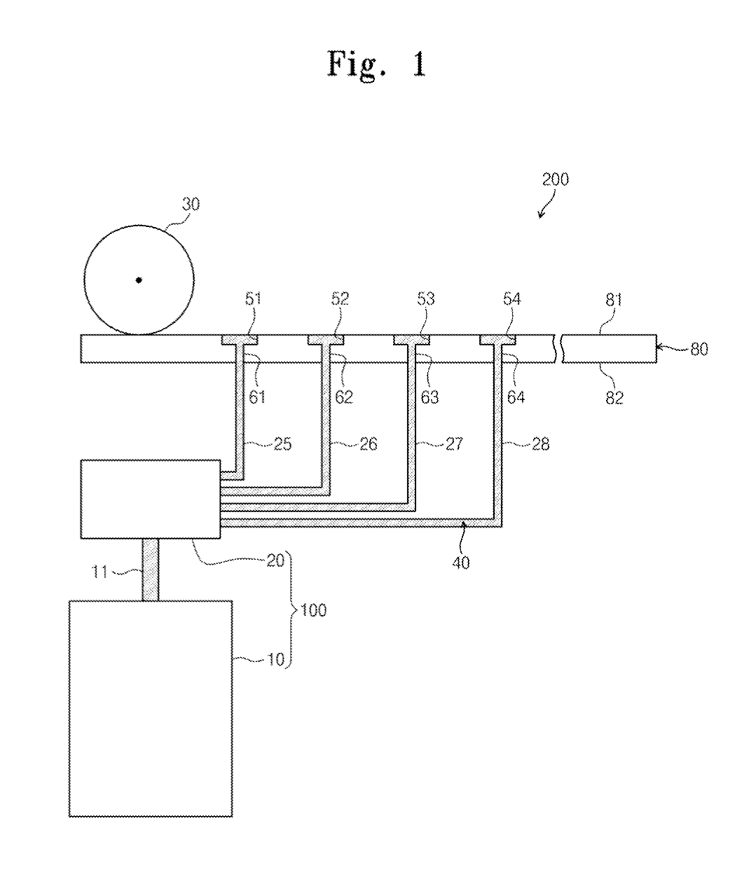

FIG. 1 is a side view of a printing apparatus 200 according to one embodiment of the present invention.

Referring to FIG. 1, the printing apparatus 200 includes a feeding part 100, a master board 80 and a transfer member 30.

The feeding part 100 feeds ink 40 toward the master board 80. The feeding part 100 includes first to fourth convey pipes 25 to 28, a controller 20 and a storage unit 10.

The storage unit 10 includes a holding space and stores the ink 40. The ink is supplied to the controller 20 through a supply pipe 11. Upon receiving the ink 40 from the storage unit 10, the controller 20 supplies the ink 40 to the master board 80 through the first to fourth convey pipes 25 to 28, and controls the amount of the ink 40 supplied to the master board 80. According to the exemplary embodiment shown in FIG. 1, the controller 20 may include a cylinder capable of controlling the amount of fluid supplied to the convey pipes 25, 26, 27, 28.

The master board 80 has a first plane 81 with first to fourth patterned reservoirs 51 to 54 formed therein. In addition, the master board 80 includes first to fourth injection holes 61 to 64 that extend through the master board 80 from a second plane 82 to the first plane 81. As shown in FIG. 1, the second plane 82 is opposite to the first plane 81. Each of the first to fourth injections holes 61, 62, 63, 64 correspond to the first to fourth patterned reservoirs 51, 52, 53, 54, respectively. Each patterned reservoir 51/52/53/54 receives ink 40 from one injection hole 61/62/63/64 such that there is a one-to-one correspondence between the patterned reservoirs and the injection holes. In the embodiment of FIG. 1, the patterned reservoirs 51, 52, 53, 54 are shown to be wider than the diameter of the convey pipes 25, 26, 27, 28. However, this is not a limitation of the invention.

The first to fourth patterned reservoirs 51 to 54 can be formed by partially removing the first plane 81 of the master board 80. The first to fourth patterned reservoirs 51 to 54, when seen in plan view, may have shapes corresponding to shapes of the patterns to be formed by using the master board 80.

As the ink 40 is supplied to the master board 80 from the storage unit 10, the ink 40 fills up the first to fourth patterned reservoirs 51 to 54 and becomes exposed to the outside. Thus, when the transfer member 30 moves along the first plane 81, the ink 40 filled in the first to fourth patterned reservoirs 51 to 54 is transferred to the transfer member 30.

The first to fourth injection holes 61 to 64 are connected to the first to fourth convey pipes 25 to 28, respectively. As a result, the ink 40 is fed into the first to fourth patterned reservoirs 51 to 54 through the first to fourth injection holes 61 to 64. For instance, the ink supplied through the first convey pipe 25 can be fed into the first patterned reservoirs 51 through the first injection hole 61.

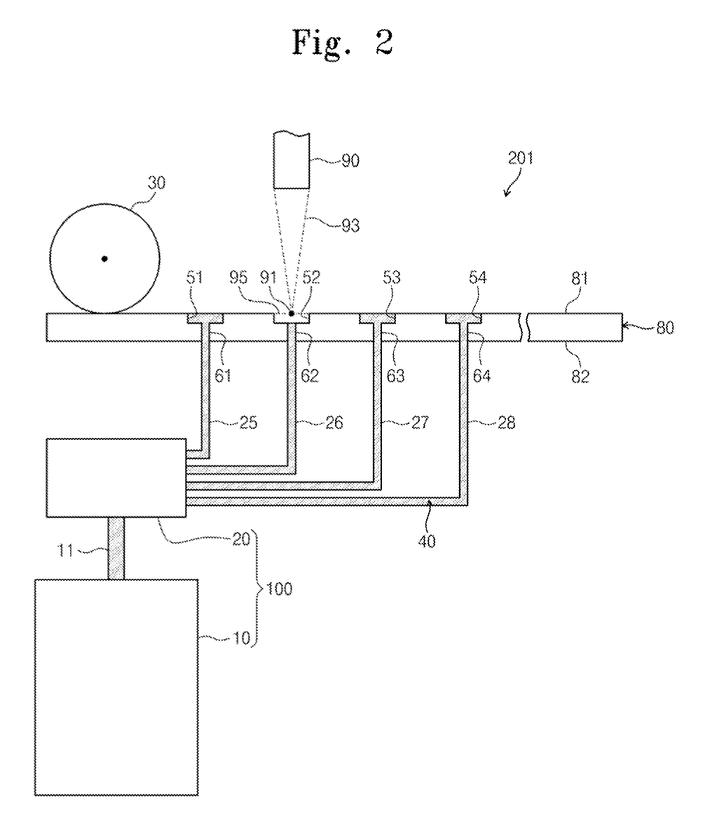

FIG. 2 is a side view of a printing apparatus 201 according to another exemplary embodiment of the present invention. When compared with the printing apparatus 200 shown in FIG. 1, the printing apparatus 201 further includes a detector 90. Thus, the following description will be focused on the detector 90 and detailed description of other components of the printing apparatus 201 will be omitted in order to avoid redundancy.

Referring to FIG. 2, the printing apparatus 201 includes the feeding part 100, the master board 80, the transfer member 30 and the detector 90.

The detector 90 detects the top surface of the ink 40 filled in the first to fourth patterned reservoirs 51 to 54. For instance, when the ink 40 is filled in the second patterned reservoir 52 through the second injection hole 62, the detector 90 is located above the second patterned reservoir 52 to detect the top surface of the ink 40 filled in the second patterned reservoir 52.

In the present exemplary embodiment shown in FIG. 2, the detector 90 produces a laser beam 93 to monitor the level of the top surface of the ink 40 and a focal point 91 of the laser beam 93 is located on a virtual plane 95 that coincides with the first plane 81. Thus, when the top surface of the ink 40 filled in the second patterned reservoir 52 reaches the focal point 91, the detector 90 may detect that the top surface of the ink 40 is level with the virtual plane 95.

When the detector 90 detects that the top surface of the ink 40 is on the same plane with the virtual plane 95, the supply of the ink 40 to the first to fourth patterned reservoirs 51 to 54 from the feeding part 100 stops. This way, the ink 40 may not overflow the first to fourth patterned reservoirs 51 to 54.

Meanwhile, as shown in FIG. 2, the virtual plane 95 preferably coincides with the first plane 81. When the virtual plane 95 is located higher (closer to the detector 90) than the first plane 81, the ink 40 may overflow out of the first to fourth patterned reservoirs 51 to 54, requiring the ink 40 on the first plane 81 to be removed by using a blade. In contrast, when the virtual plane 95 is located lower (farther away from the detector 90) than the first plane 81, the amount of the ink 40 fed into the first to fourth patterned reservoirs 51 to 54 is insufficient to fill the patterned reservoirs 51-54 and the ink 40 may not be sufficiently transferred to the transfer member 30.

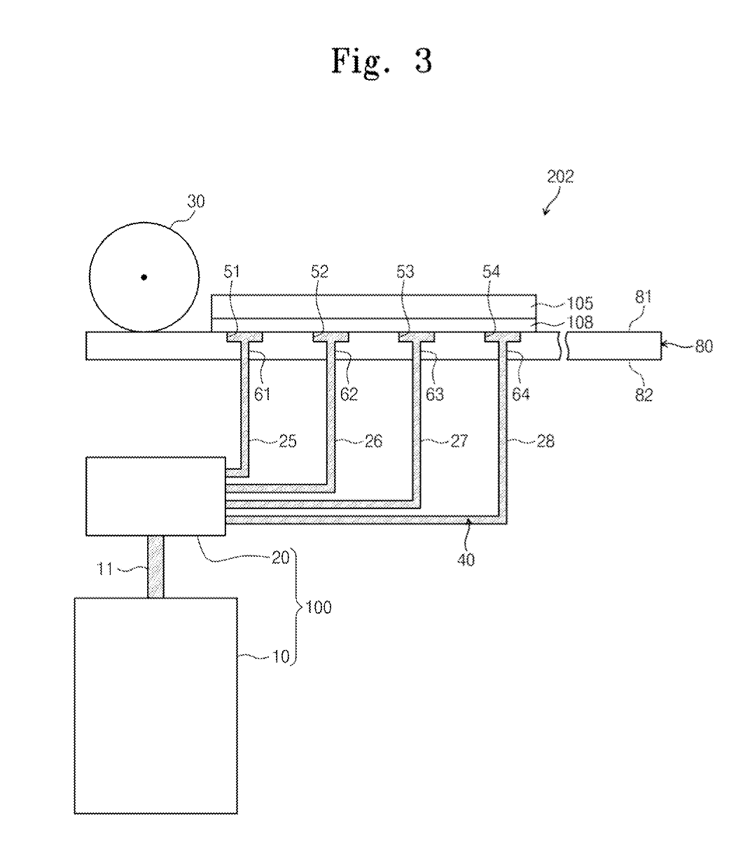

FIG. 3 is a side view of a printing apparatus 202 according to still another exemplary embodiment of the present invention.

When comparing with the printing apparatus 200 shown in FIG. 1, the printing apparatus 202 further includes first and second cover members 105 and 108. Thus, the following description will be focused on the first and second cover members 105 and 108 and detailed description of other components of the printing apparatus 201 will be omitted in order to avoid redundancy.

Referring to FIG. 3, the printing apparatus 202 includes the feeding part 100, the master board 80, the transfer member 30 and the first and second cover members 105 and 106.

The first cover member 105 is laid on the first plane 81 of the master board 80 to cover the first to fourth patterned reservoirs 51 to 54. Thus, when the ink 40 is fed to the first to fourth patterned reservoirs 51 to 54, the first cover member 105 prevents the ink 40 from overflowing out of the first to fourth patterned reservoirs 51 to 54. Preferably, the first cover member 105 includes a material having a high specific gravity, such as a metal, to prevent movement or lifting of the first cover member 105 caused by the pressure of the ink 40 filling the first to fourth patterned reservoirs 51 to 54.

Meanwhile, according to the exemplary embodiment shown in FIG. 3, the second cover member 108 may be further disposed between the master board 80 and the first cover member 105. The second cover member 108 is laid on the first plane 81 of the master board 80 to cover the first to fourth patterned reservoirs 51 to 54.

The second cover member 108 is coated with a material having surface energy different from surface energy of the ink 40, so the ink 40 may not adhere to the surface of the first cover member 105 when the first cover member 105 is separated from the master board 80. According to the embodiment shown in FIG. 3, the second cover member 108 is coated with DLC (diamond-like carbon) having surface energy higher than surface energy of the ink 40.

In addition, different from the exemplary embodiment shown in FIG. 3, the cover member 105 can be coated with a material having a surface energy different from surface energy of the ink 40. In this case, the second cover member 108 can be omitted and the first cover member 105 substitutes for the second cover member 108.

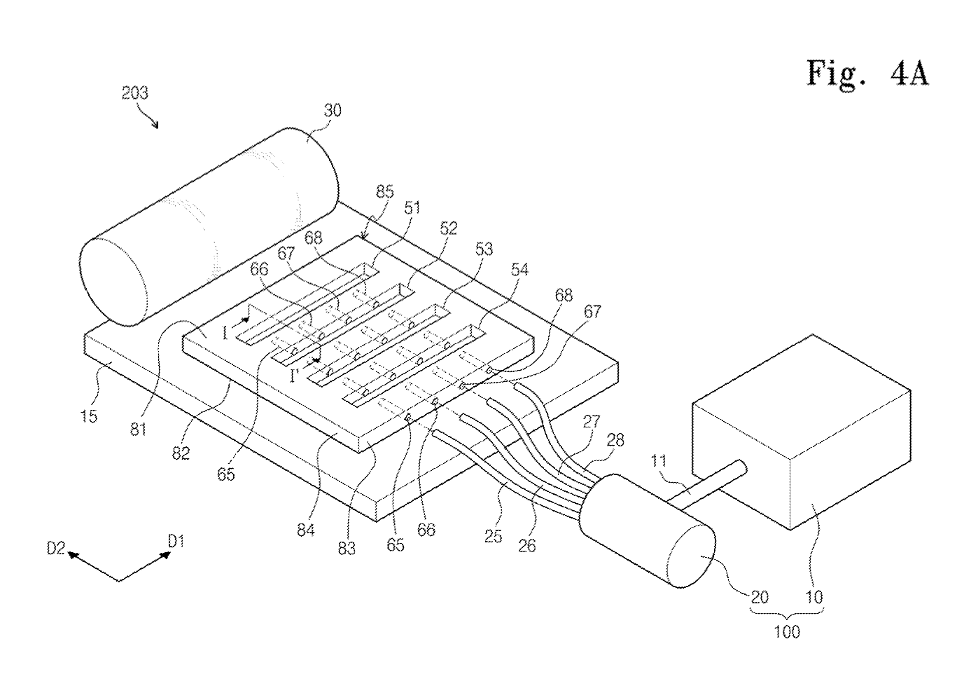

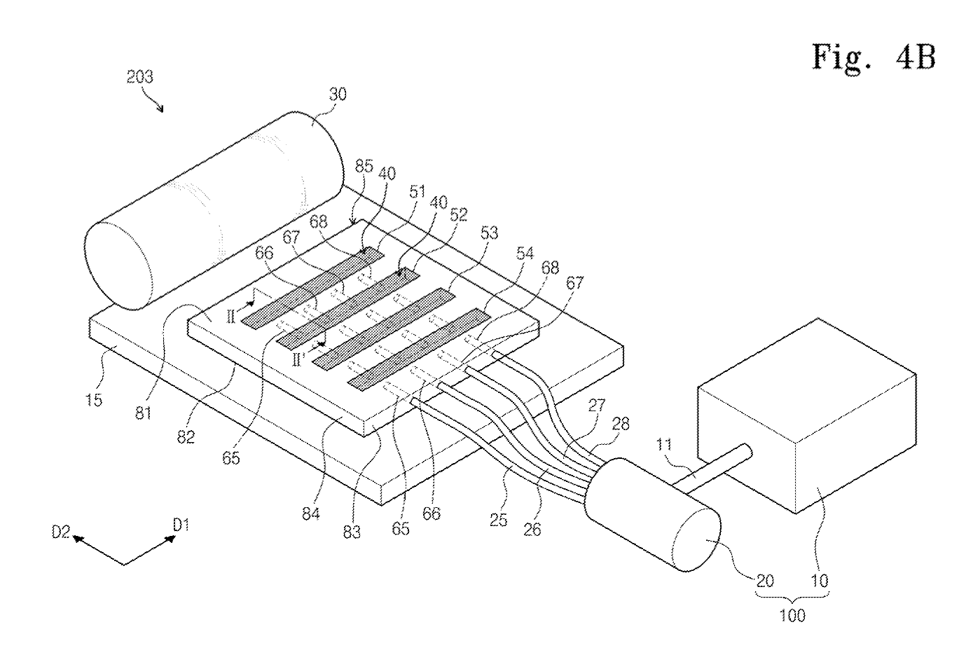

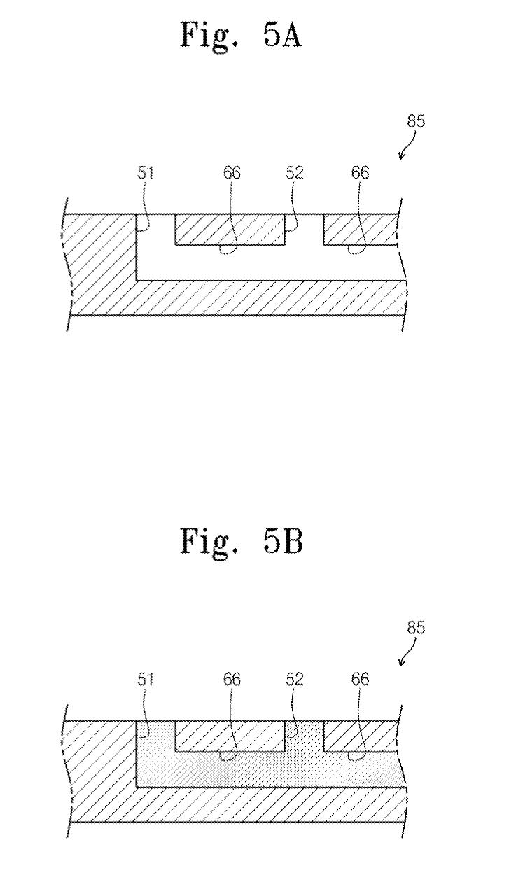

FIGS. 4A and 4B are perspective views of a printing apparatus 203 according to still another exemplary embodiment of the present invention. In detail, FIG. 4A shows a master board 85 which is not filled with the ink 40, and FIG. 4B shows the master board 85 filled with the ink 40. FIG. 5A is a sectional view taken along line I-I′ of FIG. 4A and FIG. 5B is a sectional view taken along line II-IF of FIG. 4B.

The positions of first to fourth injection holes 65 to 68 of the printing apparatus 203 shown in FIGS. 4A and 4B are different from the positions of first to fourth injection holes 61 to 64 of the printing apparatus 200 shown in FIG. 1. Thus, the following description will be focused on the positions of the first to fourth injection holes 65 to 68 and relative positions of other components, and detailed description of other components of the printing apparatus 203 will be omitted in order to avoid redundancy.

Prior to explaining FIGS. 4A and 4B and FIGS. 5A and SB, referring again to FIG. 1, the first to fourth injection holes 61 to 64 formed in the master board 80 extend through the inside of the master board 80. More specifically, the first to fourth injection holes 61 to 64 extend through the thickness of the master board 80 from the second plane 82 and correspond to the first to fourth patterned reservoirs 51 to 54, respectively.

In contrast, referring to FIGS. 4A and 5A, the first to fourth injection holes 65 to 68 formed in the master board 85 extend from a first lateral side 83 to the first to fourth patterned reservoirs 51 to 54. Unlike in the embodiments of FIG. 1 and FIG. 2, where there is a one-to-one correspondence between first to fourth injection holes 61-64 and the first to fourth patterned reservoirs 51-54, each of the pattern reservoirs 51, 52, 53, 54 receives ink 40 from the first to fourth injection holes 65 to 68. For instance, the first injection hole 65 is connected to the first to fourth patterned reservoirs 51 to 54 by extending from the first lateral side 83 through the inside of the master board 85.

According to the exemplary embodiment shown in FIG. 4A, the length direction of the first to fourth patterned reservoirs 51 to 54 is parallel to the first direction D1 and the first to fourth injection holes 65 to 68 extend in the second direction D2 substantially perpendicular to the first direction D1 in the master board 85. As a result, the first to fourth injection holes 65 to 68 intersect the first to fourth patterned reservoirs 51 to 54, so that the ink 40 (see, FIG. 4B) can be fed to the first to fourth patterned reservoirs 51 to 54 from one or more of the first to fourth injection holes 65 to 68.

Meanwhile, different from the exemplary embodiment shown in FIG. 4A, the first to fourth injection holes 65 to 68 formed in the master board 85 may extend from a second lateral side 84, which shares an edge with the first lateral side 83, to the first to fourth patterned reservoirs 51 to 54 in one-to-one correspondence by passing through the inside of the master board 85.

As described above, since the first to fourth injection holes 65 to 68 extend from the first lateral side 83 by passing through the inside of the master board 85, the first to fourth convey pipes 25 to 28 may not overlap with the master board 85 when viewed in a plan view. As a result, a support member 15 can be provided under the master board 85 without interfering with the first to fourth convey pipes 25 to 28, so that the support member 15 can support the master board 85 when the transfer member 50 rolls on the first plane 81 of the master board 85.

Referring to FIGS. 4B and 5B, the feeding part 100 feeds the ink 40 to the master board 85 through the first to fourth convey pipes 25 to 28, so that the ink 40 fills the first to fourth patterned reservoirs 51 to 54.

Although not shown in FIGS. 4B and 5B, the detector 90 (see, FIG. 2) or the first and second cover members 105 and 108 (see, FIG. 3) can be used to fill the first to fourth patterned reservoirs 51 to 54 with a predetermined amount of ink 40.

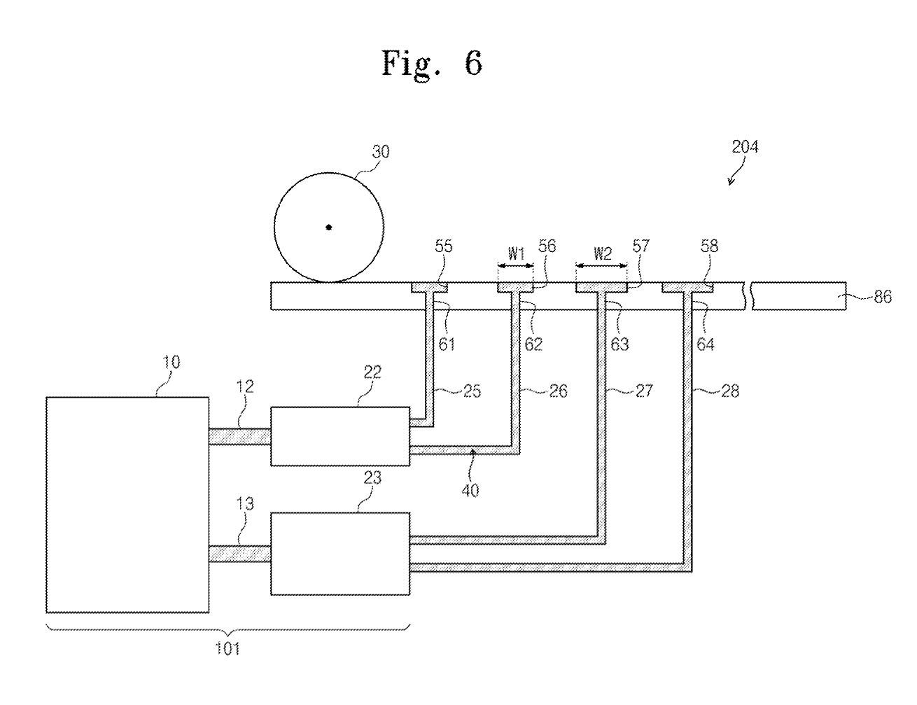

FIG. 6 is a side view of a printing apparatus 204 according to still another embodiment of the present invention. Detailed description of elements and structures that have been described with reference to FIG. 1 will be omitted in order to avoid redundancy and the same reference numerals will be used to refer to the same elements.

Referring to FIG. 6, the printing apparatus 204 includes a feeding part 101, a master board 86, and the transfer member 30.

The feeding part 101 feeds the ink 40 to the master board 86. The feeding part 101 includes first to fourth convey pipes 25 to 28, a first controller 22, a second controller 23 and a storage unit 10.

The first controller 22 is connected to the storage unit 10 through a first feeding pipe 12 to receive the ink 40 from the storage unit 10, and supplies the ink 40 to the first and second patterned reservoirs 55 and 56 through the first and second convey pipes 25 and 26. The first controller 22 controls the amount of ink 40 supplied to the first and second patterned reservoirs 55 and 56.

The second controller 23 is connected to the storage unit 10 through a second feeding pipe 13 to receive the ink 40 from the storage unit 10, and supplies the ink 40 to the third and fourth patterned reservoirs 57 and 58 through the third and fourth convey pipes 27 and 28. The second controller 23 controls the amount of ink 40 supplied to the third and fourth patterned reservoirs 57 and 58.

Meanwhile, according to the exemplary embodiment shown in FIG. 1, the same amount of ink 40 is filled in the first to fourth patterned reservoirs 51 to 54, respectively. However, according to the exemplary embodiment shown in FIG. 6, the first and second patterned reservoirs 55 and 56 have a first width W1 and the third and fourth patterned reservoirs 57 and 58 have a second width W2 larger than the first width WI. As a result, a first amount of ink 40 fills up the first and second patterned reservoirs 55 and 56, and a second amount of ink 40, which is greater than the first amount of ink 40, fills up the third and fourth patterned reservoirs 57 and 58.

That is, the amount of the ink 40 that is used to fill the first and second patterned reservoirs 55 and 56 is different from the amount of the ink 40 that is used to fill the third and fourth patterned reservoirs 57 and 58, so the first amount of the ink 40 is controlled by the first controller 22 and the second amount of the ink 40 is controlled by the second controller 23 capable of controlling a larger amount of ink 40 as compared with the first controller 22.

Meanwhile, in an alternative embodiment, at least three patterned reservoirs having various volumes different from each other can be provided in a master board. In this case, at least three controllers are provided to control the amount of the ink supplied to at least three patterned reservoirs.

Although FIG. 6 shows the first and second controllers 22 and 23 connected to one storage unit 10, the first and second controllers 22 and 23 can be connected to two separate storage units, which may be different from each other. When the first and second controllers 22 and 23 are connected to two storage units different from each other, inks having various physical properties can be supplied to the first and second controllers 22 and 23, respectively. For instance, red ink can be supplied to the first controller 22 and blue ink can be supplied to the second controller 23. Thus, the red ink can fill the first and second patterned reservoirs 55 and 56 by the first controller 22 and the blue ink can fill the third and fourth patterned reservoirs 57 and 58 by the second controller 23, so that the patterns having various colors can be formed by using the master board 86.

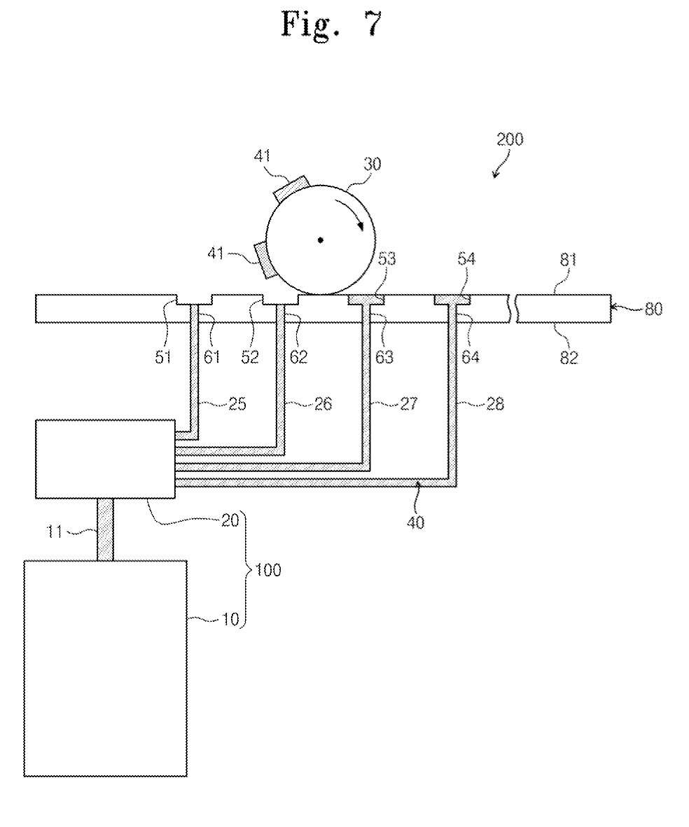

FIGS. 7 to 9 are views showing a method of forming the pattern using the printing apparatus shown in FIG. 1. In the following description of FIGS. 7 to 9, details of the elements and structures that have been previously described will be omitted in order to avoid redundancy and the same reference numerals will be assigned to the same elements.

Referring to FIG. 7, the ink 40 stored in the storage unit 10 is supplied to the controller 20 through the feeding pipe 11, and the controller 20 feeds the ink 40 to the first to fourth patterned reservoirs 51 to 54 through the first to fourth convey pipes 25 to 28. As a result, the ink 40 is filled in the first to fourth patterned reservoirs 51 to 54.

Meanwhile, although not shown in FIG. 7, the detector 90 shown in FIG. 2 or the first and second cover members 105 and 108 shown in FIG. 3 may be employed in order to prevent the ink 40 from overflowing out of the first to fourth patterned reservoirs 51 to 54 when the ink 40 is filled in the first to fourth patterned reservoirs 51 to 54.

After that, the transfer member 30 rolls along the first plane 81, so that the ink 40 filled in the first to fourth patterned reservoirs 51 to 54 is transferred to the surface of the transfer member 30. As a result, a preliminary pattern 41 is formed on the surface of the transfer member 30.

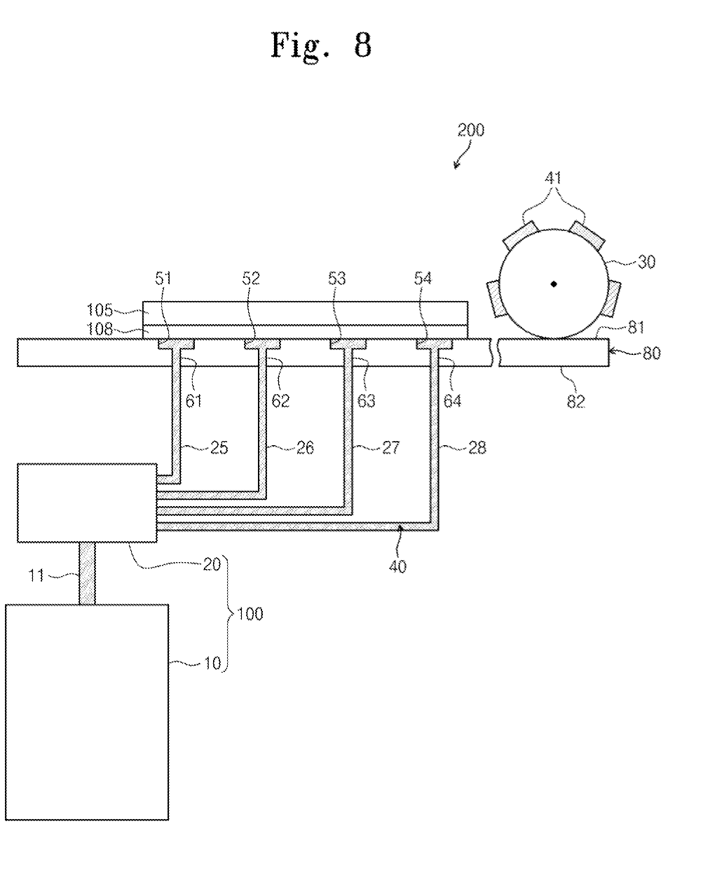

Referring to FIG. 8, after the preliminary pattern 41 has been formed on the surface of the transfer member 30, the first and second cover members 105 and 108 are sequentially disposed on the first plane 81, and the controller 20 supplies the ink 40 to the first to fourth patterned reservoirs 51 to 54, so that the ink 40 again fill up the first to fourth patterned reservoirs 51 to 54.

When the ink 40 fills the first to fourth patterned reservoirs 51 to 54, the first and second cover members 105 and 108 prevent the ink 40 from overflowing out of the first to fourth patterned reservoirs 51 to 54.

In addition, when the ink 40 again fills the first to fourth patterned reservoirs 51 to 54 after the preliminary pattern 41 has been formed on the surface of the transfer member 30, the controller 20 can supply the ink 40 corresponding to the amount of ink 40 transferred to the surface of the transfer member 30 to the first to fourth patterned reservoirs 51 to 54. Thus, the amount of the ink 40 can be diminished when the ink 40 is again filled in the first to fourth patterned reservoirs 51 to 54.

Meanwhile, when the ink 40 again fill up the first to fourth patterned reservoirs 51 to 54, the predetermined amount of ink 40 can be filled in the first to fourth patterned reservoirs 51 to 54 by using the detector 90 shown in FIG. 2, instead of using the first and second cover members 105 and 108.

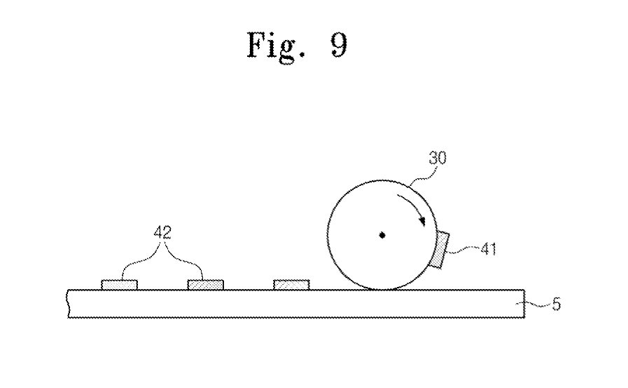

Referring to FIG. 9, the transfer member 30 having the preliminary pattern 41 on its surface rolls on the substrate 5. As the transfer member 30 rolls, the preliminary pattern 41 is transferred to the substrate 5, so that the pattern 42 is formed on the substrate 5. Then, the pattern 42 is cured through a heat treatment process.

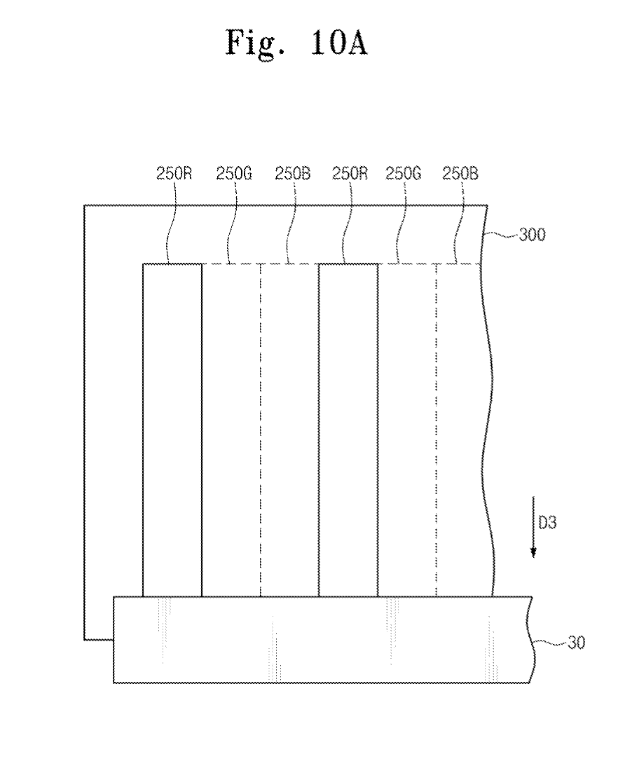

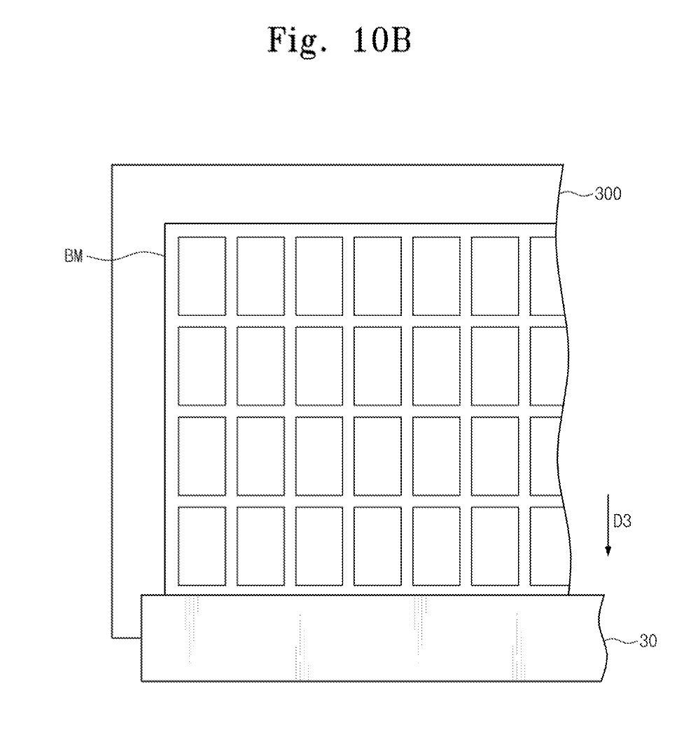

FIGS. 10A and 10B are views showing a method of forming a color filter pattern and a black matrix pattern on a substrate of a display apparatus by using the method that is depicted in FIGS. 7 to 9.

Referring to FIG. 10A, a red filter pattern 250R can be formed on a base substrate 300 by using the method of forming the pattern shown in FIGS. 7 to 9. In the embodiment shown in FIG. 10A, the red filter pattern 250R can be formed by using red ink.

Referring again to FIG. 7, when the red filter pattern 250R is formed by using the red ink, a red ink fills the first to fourth patterned reservoirs 51 to 54 as the ink 40. In addition, as described above with reference to FIG. 8, the red ink is transferred to the transfer member 30 and the transfer member 30 moves on the base substrate 300 in the third direction D3, so that the red filter pattern 250R is formed on the base substrate 300.

Meanwhile, after the red filter pattern 250R has been formed on the base substrate 300, a green filter pattern 250G and a blue filter pattern 250B can be sequentially formed through the method similar to the method of forming the red filter pattern 250R.

Referring to FIG. 10B, the black matrix pattern BM can be formed on the base substrate 300 by using the method of forming the pattern shown in FIGS. 7 to 9. In the embodiment shown in FIG. 10B, the black matrix pattern BM can be formed by using black ink capable of blocking light.

Referring again to FIG. 7, when the black matrix pattern BM is formed by using the black ink, the black ink is filled in the first to'fourth patterned reservoirs 51 to 54 instead of the ink 40. In addition, as described above with reference to FIG. 8, the black ink is transferred to the transfer member 30 and the transfer member 30 moves on the base substrate 300 in the third direction D3, so that the black matrix pattern BM is formed on the base substrate 300.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A printing apparatus comprising:
a master board comprising a patterned reservoir formed on a first plane of the master board and an injection hole connected to the patterned reservoir by extending from a second plane different from the first plane through an inside of the master board; and
a feeding part feeding ink into the patterned reservoir through the injection hole.

2. The printing apparatus of claim 1, wherein the feeding part comprises:
a controller to adjust an amount of the ink that is supplied to the master board; and
a convey pipe connecting the injection hole to the controller.

3. The printing apparatus of claim 2, further comprising a first cover member provided on the first plane to cover the patterned reservoir.

4. The printing apparatus of claim 3, further comprising a second cover member interposed between the master board and the first cover member to cover the patterned reservoir and having a surface energy different from a surface energy of the ink.

5. The printing apparatus of claim 2, further comprising a detector provided above the patterned reservoir to detect a top surface of the ink filled in the patterned reservoir.

6. The printing apparatus of claim 2, wherein the patterned reservoir is provided in plurality and the controller is provided in plurality, at least two patterned reservoirs are filled with inks having volumes different from each other, and amounts of ink in at least two patterned reservoirs are adjusted by at least two controllers.

7. The printing apparatus of claim 1, wherein the first plane is a top surface of the master board, the second plane is a bottom surface of the master board, and the injection hole extends toward the patterned reservoir from the bottom surface of the master board.

8. The printing apparatus of claim 1, wherein the first plane is a top surface of the master board, the second plane is a lateral surface of the master board connecting the top surface to a bottom surface opposite to the top surface of the master board, and the injection hole extends inside the master board in a direction that crosses more than one patterned reservoir, starting from the lateral surface of the master board.

9. The printing apparatus of claim 1, further comprising a transfer member to which the ink transfers from the patterned reservoir.

10. A method of forming a pattern using a master board having a patterned reservoir formed on a first plane , the method comprising:
feeding ink into the patterned reservoir through an injection hole connected to the patterned reservoir by extending from a second plane different from the first plane through an inside of the master board;
transferring the ink from the patterned reservoir to a transfer member; and
transferring the ink from the transfer member to a substrate to form the pattern on the substrate.

11. The method of claim 10, further comprising providing a first cover member on the first plane to cover the patterned reservoir before the ink is supplied to the patterned reservoir.

12. The method of claim 11, further comprising providing a second cover member having a surface energy different from a surface energy of the ink on the first plane to cover the patterned reservoir before the first cover is provided on the first plane.

13. The method of claim 10, wherein the feeding of the ink into the patterned reservoir comprises:
detecting a position of a top surface of the ink in the patterned reservoir; and
stopping the feeding of ink into the patterned reservoir when the first plane is aligned on a same plane with the top surface of the ink.

14. The method of claim 10, wherein the ink is fed into the patterned reservoir through a convey pipe connected to the injection hole, and an amount of ink fed into the patterned reservoir is adjusted by a controller connected to the convey pipe.

15. The method of claim 14, wherein the patterned reservoir is provided in plurality and the controller is provided in plurality, at least two patterned reservoirs are filled with inks having volumes different from each other, and amounts of ink in at least two patterned reservoirs are adjusted by at least two controllers.

16. The method of claim 10, wherein the first plane is a top surface of the master board, the second plane is a bottom surface of the master board, and the injection hole extends toward the patterned reservoir from the bottom surface of the master board.

17. The method of claim 10, wherein the first plane is a top surface of the master board, the second plane is a lateral surface of the master board connecting the top surface to a bottom surface opposite to the top surface of the master board, and the injection hole extends inside the master board in a direction that crosses more than one patterned reservoir, starting from the lateral surface of the master board.

18. The method of claim 10, wherein the pattern comprises a color filter pattern formed on a substrate for a display apparatus.

19. The method of claim 10, wherein the pattern comprises a black matrix pattern formed on a substrate for a display apparatus.
